(19) United States
(12) Patent Application Publication
(10) Pub. No.: US 2008/0044537 A1
(43) Pub. Date: Feb. 21, 2008

(54) Oven rack grilling apparatus and method of use thereof

(76) Inventor: Aaron J. Manuel, Stone Mountain, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/975,526

(22) Filed: Oct. 19, 2007

Related U.S. Application Data
(63) Continuation-in-part of application No. 11/305,936, filed on Dec. 19, 2005.

(51) Int. Cl. A23L 1/01; A47J 37/04

(52) U.S. Cl. 426/523; 99/340

(57) ABSTRACT

An oven rack grilling apparatus combining an oven rack with a grilling basket, wherein the grilling basket is disposed within an aperture of a standard-sized oven rack. The rear portion of the oven rack is suitable for grilling larger portions of food, while the grilling basket may contain smaller food portions within the basket with its lid closed, or accommodate larger food portions with the lid open. The grilling basket is made of metal mesh to permit uniform exposure to radiant heat within the oven. In another configuration, a rotisserie may be placed within the aperture of the oven rack, with or without the grilling basket present. The rotisserie permits rotation of food disposed thereon.

### RELATED APPLICATION

The present Non-Provisional U.S. Utility patent application is a Continuation-in-Part of, and hereby claims priority to, and the full benefit of, Non-Provisional U.S. Utility patent application Ser. No. 11/305,936, filed 19 Dec. 2005, entitled “Oven Rack Grilling Apparatus and Method of Use Thereof,” hereby incorporated by reference.

### TECHNICAL FIELD

The present invention relates generally to racks for grilling, broiling, or baking food, and, more specifically, to a grilling apparatus comprising a rack having interchangeable components to allow preparation of various types of food according to various techniques.

### BACKGROUND OF THE INVENTION

Many consumers prefer to grill their food to accomplish an evenly cooked, browned meat or vegetable. Unfortunately, consumers who live in condominiums or apartments are often not permitted to operate grills on their premises. Other consumers prefer to grill only occasionally and choose to avoid the expense of an outdoor grill and rely instead on the oven already in their home. Additionally, grills can be difficult to clean and require potentially hazardous fuel, such as propane or natural gas in tanks, or charcoal and lighter fluid.

On the other hand, ovens are readily available in almost every home, are easily cleaned, and are safely fueled, such as via electricity or via piped natural gas. Ovens typically have shelf racks, wherein a frame of rails defines a periphery of the rack with a middle rail disposed approximately midway between the front and rear of the frame, and bars disposed perpendicular to the middle rail. In such fashion, large food pieces and/or portions, or smaller pieces and/or portions in a heat-proof container, can be cooked within the oven by placement on the rack. However, smaller pieces and/or portions would disadvantageously fall through the rack, if not otherwise contained.

Further, many individuals may prefer, at least in some instances, to have their food browned by direct exposure to cooking radiation, rather than cooked in a container. Unfortunately, loose vegetable pieces and small pieces of meat that require open access to heat for browning will not cook properly in a solid surface container, and cannot be placed on the oven rack without falling through the gaps between the bars and rails of the rack.

Therefore, there persists the need for a solution to enable grilling of small pieces and/or portions of food in a conventional oven, whereby the food item may be browned by direct radiation from the heating elements of the oven.

### BRIEF SUMMARY OF THE INVENTION

Briefly described, the present invention overcomes the above-mentioned disadvantages and meets the recognized need for such a device by providing a grilling apparatus having a standard-sized oven rack with an aperture therein suitable for receiving a grilling basket for containing individual food items. As such, the present invention may be utilized for cooking food items of any desired size or type in an oven without the need for a pan to hold the food items. Accordingly, food, whether placed directly on the rack or disposed within the basket, may be exposed to heat from radiating elements within the oven, permitting grilling and browning of the food items as desired by the user. A rotisserie spit is, likewise, engageable with the aperture for allowing rotisserie cooking of food items. A drip pan is provided that is engageable with the rack and/or the rotisserie, whereby juice, fat, or crumbs may be collected for subsequent disposal to prevent soiling.

According to its major aspects and broadly stated, the present invention in its preferred form is a grilling apparatus comprising a combination of a rack with an aperture for selectively receiving one or both of a grilling basket and a rotisserie spit. A portion of the oven rack proximate the aperture is suitable for grilling larger portions of food, while the aperture is used with the grilling basket and/or the rotisserie spit. The grilling basket may contain smaller food pieces and/or portions therewithin with a lid in a closed position, or may accommodate larger food pieces and/or portions with the lid open. The grilling basket is comprised of metal mesh to permit uniform exposure to radiant heat within the oven, and wherein additional food items may be disposed on top of the lid in the closed position, thereby increasing a cooking surface area of the rack. The rotisserie spit is adapted for grilling fowl, such as turkey, chicken, duck, quail, and/or Cornish hens, and/or other meat portions, such as roasts, racks, rumps or other cuts of beef, lamb, venison, and/or the like. The rotisserie permits manual rotation of food disposed thereon for even cooking therearound.

More specifically, the present invention comprises a grilling apparatus in the form of an oven rack or a grill rack having an aperture formed therein for receiving a removable grilling basket and/or a rotisserie spit. The rack comprises a frame and an aperture for holding the grilling basket, and left and right rails for supporting a rotisserie device and for defining the sides of the aperture. The left and right rotisserie rails comprise supports to retain a removable rotisserie within the oven rack. A middle rail separately divides a front portion and a rear portion of the oven rack, wherein the front portion comprises the aperture for the grilling basket and/or the rotisserie spit, such that the grilling basket or the rotisserie spit may be easily accessed for removal or manipulation.

Additionally, the removable grilling basket comprises a well and a hinged lid covering the well, wherein the well is formed from metal mesh material or the like. Left and right handles are disposed on respective left and right sides or walls of the grilling basket to enable convenient carriage and placement thereof. Hanger hooks are disposed at the junctures of the walls of the basket well, wherein the hanger hooks engage the rotisserie rails and support the removable grilling basket within the aperture of the oven rack. The lid is secured to a wall of the basket via hinges to enable opening and closing thereof. A fastener is disposed on a portion of the lid opposite the hinges to engage a wall of the basket, thereby enclosing an interior of the grilling basket. The grilling basket can be readily cleaned in a typical dishwasher subsequent to use.

To use the oven rack grilling apparatus, food items, such as meat or vegetable pieces, may be placed in the removable grilling basket and the removable grilling basket may be subsequently installed within the aperture of the oven rack, supported therewithin via the hanger hooks. The combined oven rack grilling apparatus is subsequently inserted into an oven by placement on existing rails. A pan may be placed below the rack to catch drippings or crumb droppings, or a drip pan may be engaged with the grilling basket or the rack to collect such drippings to prevent accumulation thereof within the oven. The food items can then be cooked as desired over a typical oven temperature range, such as from approximately 200 degrees Fahrenheit to approximately 500 degrees Fahrenheit.

In place of, or in addition to the grilling basket, a rotisserie may engaged with the oven rack, whereby coincident rotisserie cooking of food items, such as those that require or benefit from rotation, and grilling of loose food items, such as vegetable pieces is facilitated. Accordingly, the lid of the basket may be left open, wherein the open lid is disposed proximate the bars forming the rear portion of the oven rack. The rotisserie, with food secured thereto, may be subsequently disposed within the removable grilling basket, and supported via the left and right rotisserie supports, wherein the rotisserie supports permit rotation of the food to allow even cooking and/or browning therearound.

Accordingly, a feature and advantage of the present invention is its ability to support small portions of food within an oven or a grill while permitting generally direct access to radiation from cooking elements within the oven or the grill over a substantial portion of an exterior thereof.

Another feature and advantage of the present invention is its ability to accommodate a rotisserie within the rack.

Still another feature and advantage of the present invention is its ability to retain small portions of food enclosed so that they do not fall from the rack.

Yet another feature and advantage of the present invention is that it can replace a standard oven rack for home or industrial ovens.

Yet still another feature and advantage of the present invention is its ability to permit grilling and rotisserie cooking of food in home and/or industrial ovens.

A further feature and advantage of the present invention is its ability to accommodate and coincidentally grill large pieces and/or portions of food, as well as smaller pieces and/or portions of food.

A further feature and advantage of the present invention is its ability to collect drippings and/or droppings from food items during cooking for subsequent disposal.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Invention with reference to the accompanying drawing Figures, in which like reference numerals denote similar structure and refer to like elements throughout, and in which:

FIG. 1 is a perspective view of an oven rack according to the present invention;

FIG. 2A is a perspective view of a grilling basket according to the present invention in an open configuration;

FIG. 2B is a perspective view of the grilling basket of FIG. 2A in a closed configuration;

FIG. 3 is a perspective view of a combined oven rack and grilling basket according to the present invention, shown in the closed configuration in an oven;

FIG. 4 is a perspective view of a combined oven rack and grilling basket according to the present invention, shown in the open configuration in an oven;

FIG. 5A is a perspective view of an oven rack according to the present invention including a rotisserie spit; and,

FIG. 5B is a detail view of a connection portion of the rotisserie spit of FIG. 5A;

FIG. 6 is a perspective view of the grilling basket according to an alternate configuration, including a drip pan attached thereto;

FIG. 7 is an exploded perspective view of the drip pan of FIG. 6 and a grill rack;

FIG. 8 is a detail view of the drip pan and the grill rack of FIG. 7;

FIG. 9 is a perspective view of the grill rack and the drip pan of FIG. 7 shown assembled for use in a grill;

FIG. 10 is a perspective view of a rotisserie spit of the present invention according to an alternate configuration; and

FIGS. 11A-C are detail perspective views of alternate positioning means of the rotisserie spit of the present invention.

### DETAILED DESCRIPTION OF THE INVENTION

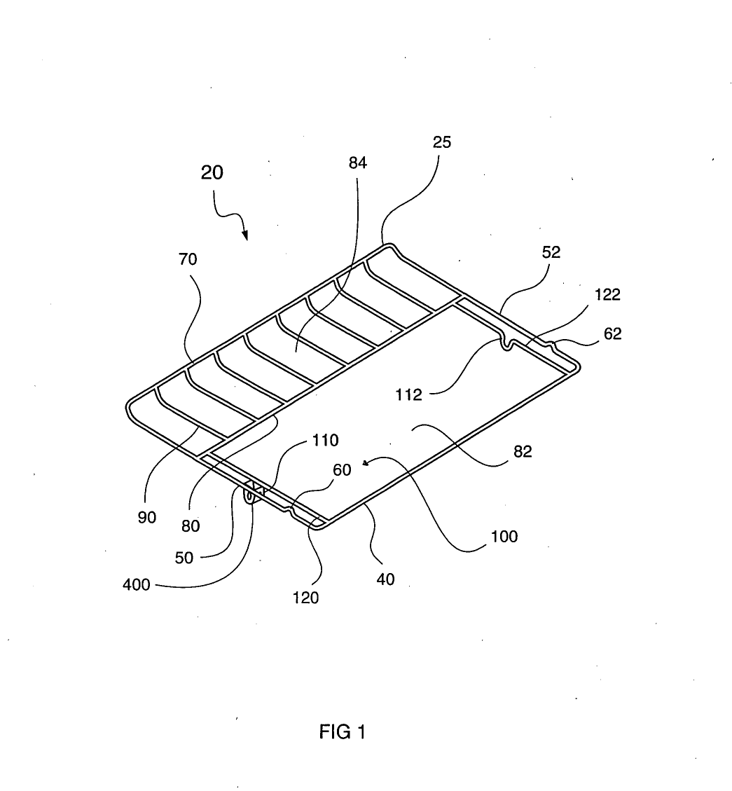

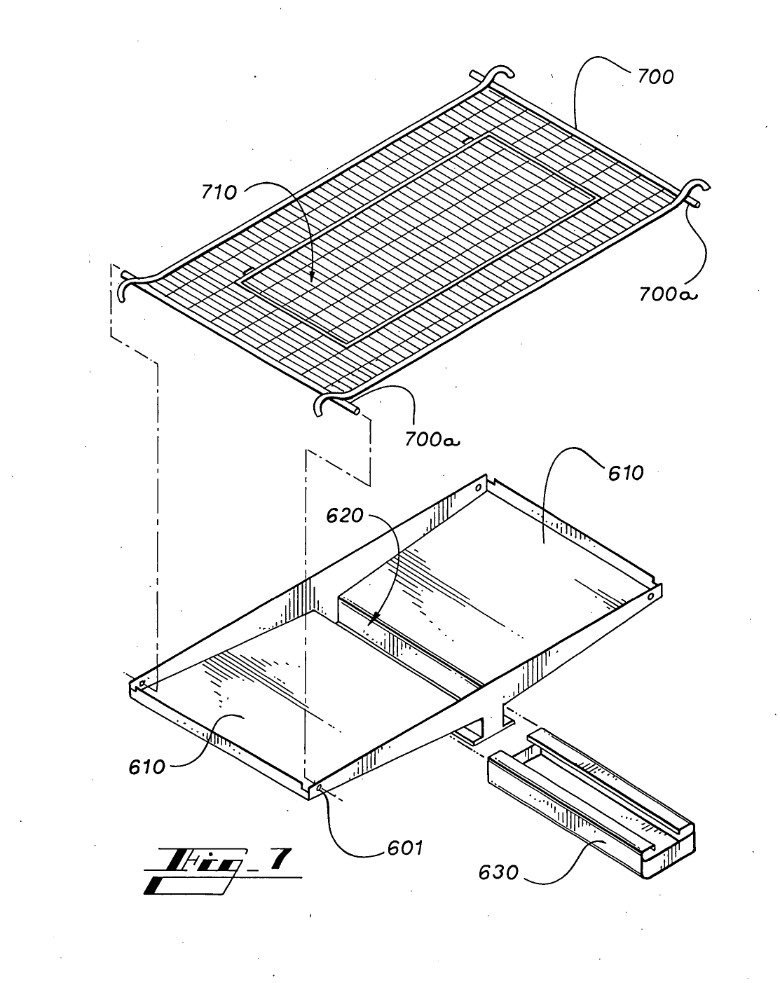

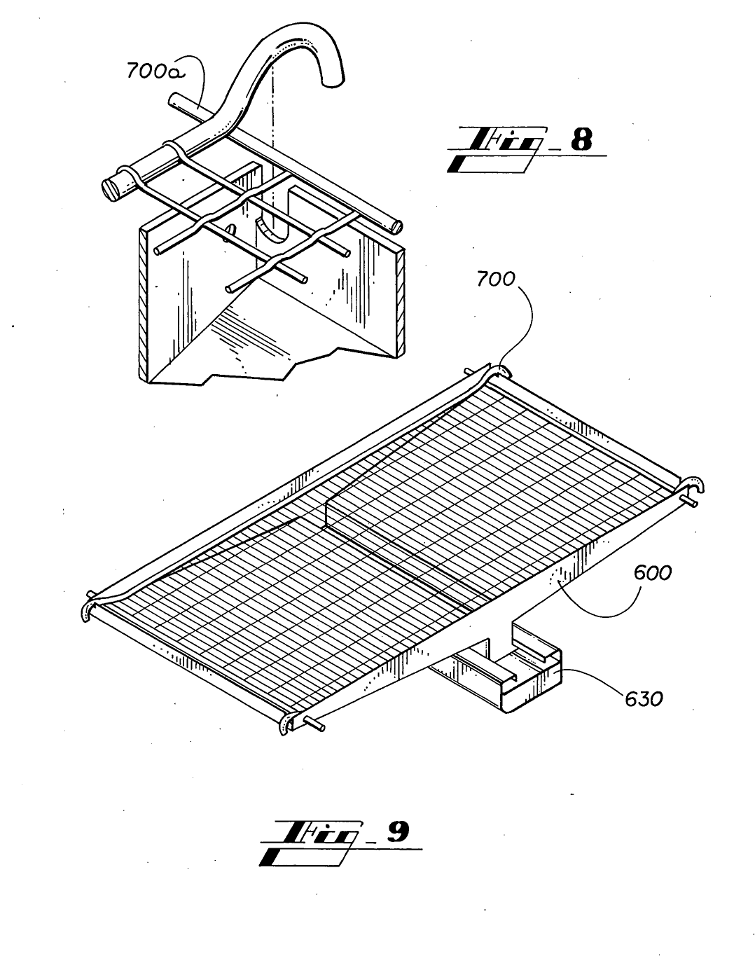

In describing the present invention, as illustrated in FIGS. 1-11C, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-4, the present invention comprises grilling apparatus 10, preferably comprising oven rack 20 and removable grilling basket 30. Turning now more specifically to FIG. 1, oven rack 20 is preferably of a size suitable for installation and use within typically-available ovens and preferably comprises frame 25 and aperture 100. Frame 25 preferably comprises front rail 40, left side rail 50, right side rail 52, back rail 70, middle rail 80, left rotisserie rail 120, right rotisserie rail 122 and bars 90, wherein middle rail 80, rear portions of side rails 50, 52 and back rail 70 form a box shape, and wherein bars 90 are approximately evenly spaced and extend perpendicularly from middle rail 80 to perpendicularly join back rail 70. Front rail 40, front portions of side rails 50, 52 and middle rail 80 preferably form a box shape. Rotisserie rails 120, 122 are disposed inboard of side rails 50, 52 and parallel thereto, extending perpendicularly from front rail 40 to connect perpendicularly to middle rail 80. Middle rail 80 along with front rail 40 and side rails 50, 52, preferably separately defines front portion 82. Middle rail 80, along with back rail 70 and side rails 50, 52, preferably separately defines rear portion 84 of oven rack 20, wherein well aperture 100 substantially encompasses front portion 82 of oven rack 20. Left side rail 50 preferably comprises left ridge 60 and right side rail 52 preferably comprises right ridge 62, wherein left ridge 60 and right ridge 62 preferably engage protrusions P on rails R within oven O in a known manner for positioning of oven racks 20 therein.

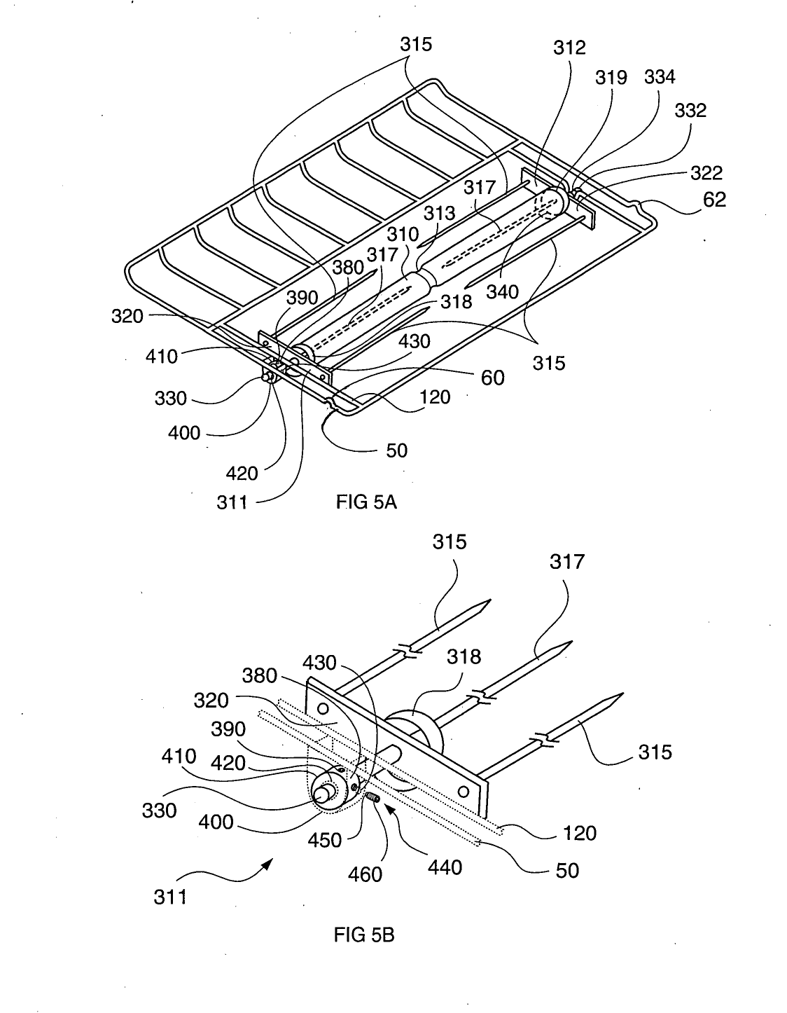

Right rotisserie rail 122 preferably comprises right rotisserie support 112, wherein right rotisserie support 112 is configured to receive rotisserie 300 therewithin (best shown in FIG. 5A). Support block 400 is fixedly secured to, and disposed under, left side rail 50 and left rotisserie rail 120, wherein support block 400 generally comprises a ‘U’-shape for receiving rotisserie 300.

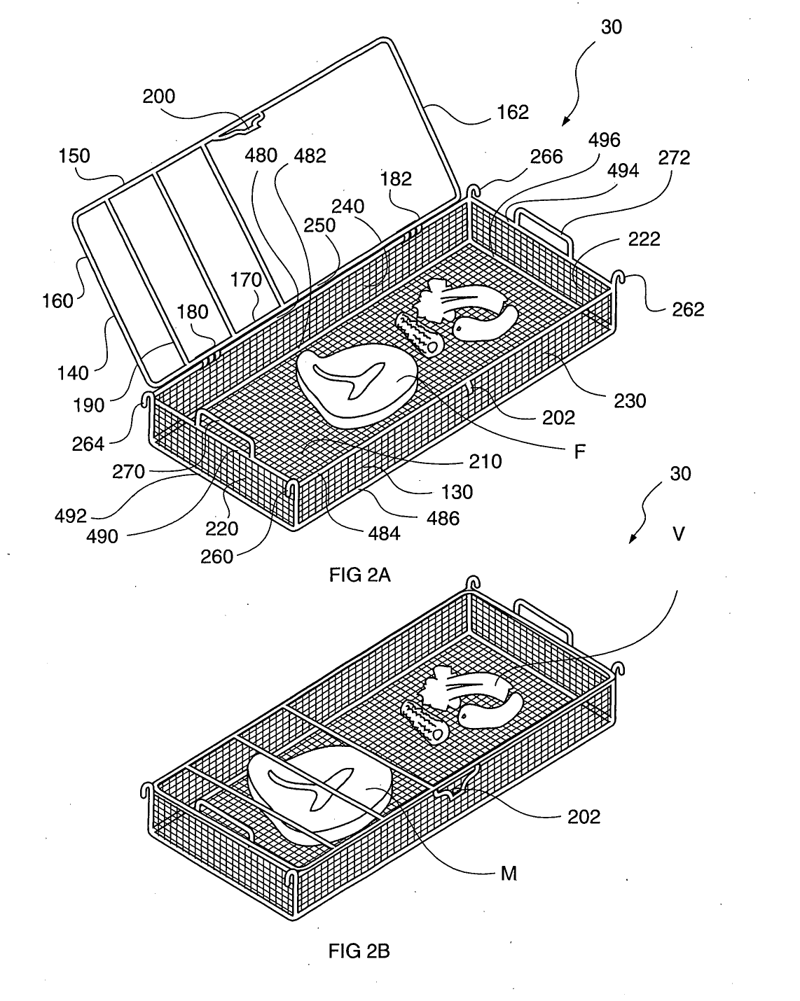

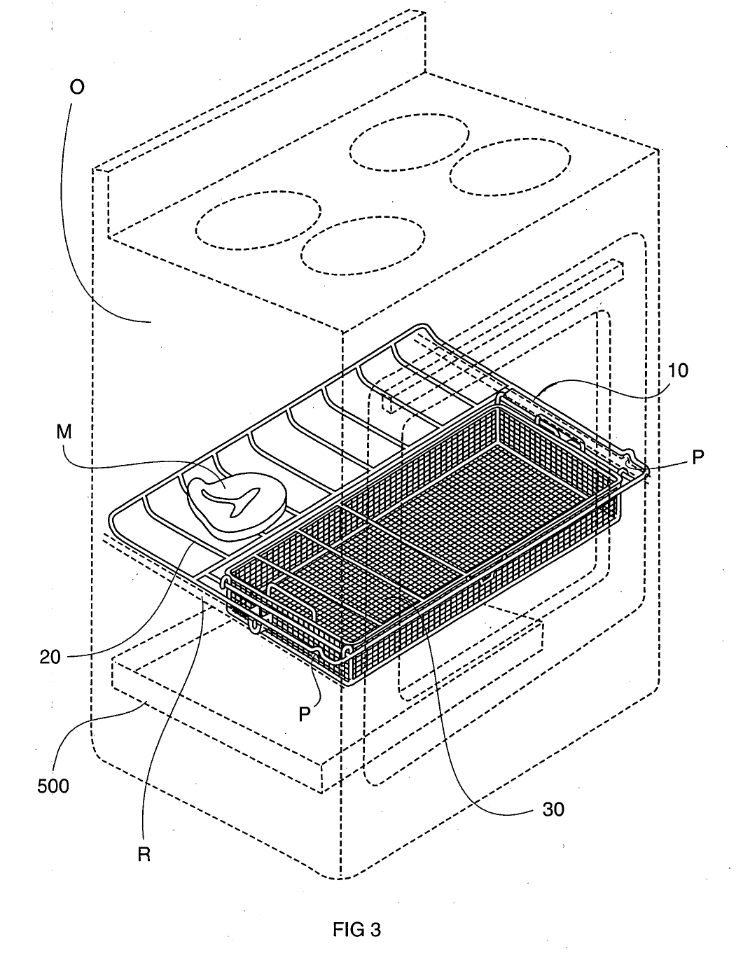

Referring more specifically to FIGS. 2A and 2B, removable grilling basket 30 preferably comprises well 130 and lid 140, wherein well 130 and lid 140 are hingedly-secured together via left hinge 180, and right hinge 182. Well 130 preferably comprises bottom 210, left wall 220, front wall 230, right wall 222 and rear wall 240, all preferably formed of metal mesh material or the like. Well 130 preferably comprises bars 480, 482, 484, 486, 490, 492, 494 and 496, wherein front bars 484, 486 and hanger hooks 260, 262 preferably define the perimeter of front wall 230, and wherein rear bars 480, 482 and hanger hooks 264, 266 preferably define the perimeter of rear wall 240. Additionally, left side bars 490, 492 and hanger hooks 260, 264 preferably define the perimeter of left wall 220, and right side bars 494, 496 and hanger hooks 262, 266 preferably define the perimeter of right side wall 222. Bottom 210 is preferably peripherally framed by front bar 486, side bars 492, 496, and rear bar 482.

Front wall 230 is preferably joined to left wall 220 via hanger hook 260 and to right wall 222 via hanger hook 262. Rear wall 240 is preferably joined to left wall 220 via hanger hook 264 and to right wall 222 via hanger hook 266. Left wall 220 and right wall 222 preferably respectively comprise left handle 270 and right handle 272. Handles 270, 272 could be either be rigidly-attached or hingedly-attached to side rods 490, 494, and/or could extend from side bars 490, 492.

Lid 140 preferably comprises front rail 150, left side rail 160, right side rail 162, back rail 170 and bars 190, wherein back rail 170 is preferably hingedly-secured to back wall 240 of well 130 via hinges 180, 182 that are connected to back rail 170. Fastener 200 is preferably disposed on front rail 150, wherein fastener 200 preferably cooperatively engages pin 202 disposed on front wall 230 of well 130, thereby forming removable grilling basket 30 into an enclosure. It should be understood that other closure configurations could be utilized, such as snap or friction engagement means, or any other suitable means.

To assemble grilling apparatus 10, grilling basket 30 is inserted into aperture 100 of oven rack 20, as depicted in FIG. 3, wherein hanger hooks 260, 262, 264 and 266 preferably cooperatively engage rotisserie rails 120, 122, thereby supporting removable grilling basket 30 within aperture 100 of oven rack 20.

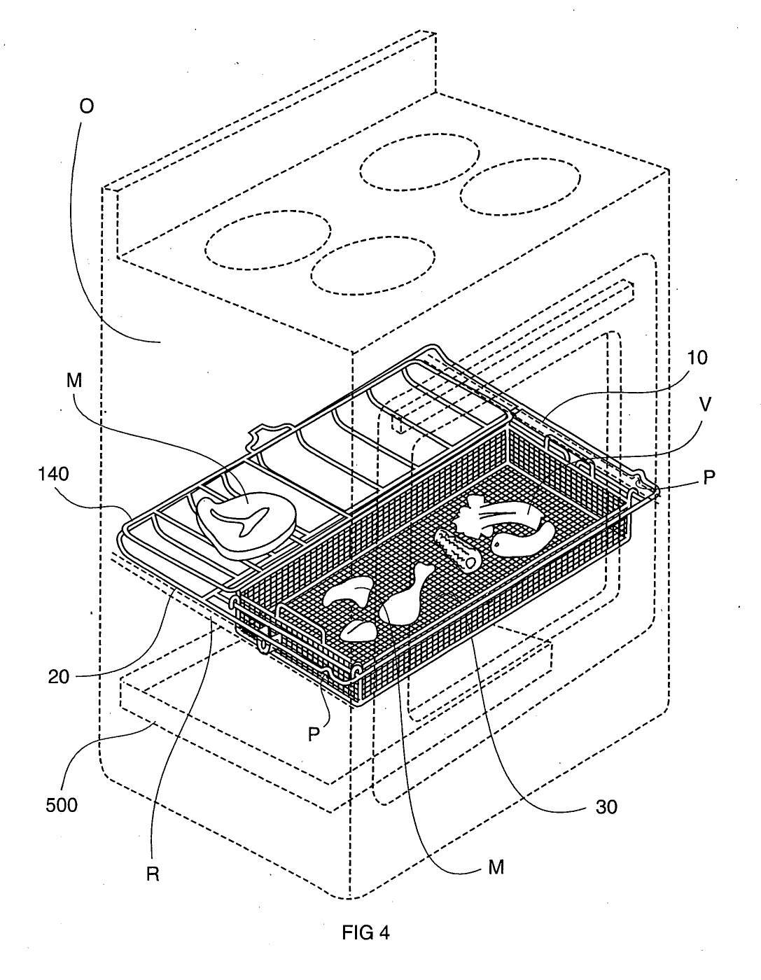

In use, food F, such as, for exemplary purposes only, meat M and vegetables V is preferably placed in removable grilling basket 30 and lid 140 is preferably closed over well 130 via fastener 200. Removable grilling basket 30 is preferably subsequently disposed within aperture 100 of oven rack 20, wherein removable grilling basket 30 is preferably supported within aperture 100 via hooks 260, 262, 264 and 266. Combined grilling apparatus 10 is preferably subsequently placed on rails R within oven O (best shown in FIGS. 3 and 4) and positioned therewithin over drip pan 500, thereby permitting cooking of food F, wherein drip pan 500 contains grease drippings.

Referring now more specifically to FIGS. 5A and B, illustrated therein is a grilling apparatus 10 according to an alternate configuration, substantially equivalent in form and function to that of the grilling apparatus 10 detailed and illustrated in FIGS. 1-4, except as hereinafter specifically referenced. Specifically, the grilling apparatus of FIGS. 5A and 5B comprises combination grilling apparatus 10, wherein combination grilling apparatus 10 further comprises rotisserie 300 disposed within oven rack 20. Rotisserie 300 is preferably manually rotated; however, rotisserie 300 could alternately be powered via a motor and power source.

Rotisserie 300 comprises tube 310, first end 311, and second end 312, wherein first end 311 comprises central stake 317, side stakes 315, plate 320, cup 318 and shaft 330, wherein stakes 315, 317 are fixedly secured to plate 320. Shaft 330 carries ring 380, wherein ring 380 comprises detents 390, and wherein ring 380 is fixedly secured to shaft 330. Second end 312 comprises central stake 317, side stakes 315, plate 322, cup 319 and shaft 332, wherein stakes 315, 317 are fixedly secured to plate 322. Shaft 332 comprises groove 334, wherein groove 334 is adapted to slidably rotate within ‘U’-shaped opening 112.

First end 311 and second end 312 can be disassembled from tube 310, wherein first end 311, second end 312 and tube 310 can be easily placed within a dishwasher for cleaning. First end 311 and second end 312 can selectively be utilized with or without tube 310, wherein tube 310 is suitable for engaging large openings, such as in fowl. When utilizing first end 311 and second end 312 with tube 310, crimp 313 serves to provide retention of central stakes 317 within tube 310.

Ring 380 comprises detents 390, wherein ring 380 engages support block 400. Support block 400 comprises throughhole 420, wherein throughhole 420 is adapted to receive first end 330. Support block 400 further comprises aperture 410 and threaded throughhole 430, wherein aperture 410 is adapted to receive ring 380.

Threaded throughhole 430 is adapted to receive locking mechanism 440, wherein locking mechanism 440 cooperatively engages threaded throughhole 430, thereby securing locking mechanism 440 within support block 400. Locking mechanism 440 comprises ball end 450 and threaded body 460, wherein ball end 450 is spring loaded, and wherein, once locking mechanism 440 and rotisserie 300 are engaged within support block 400, ball end 450 removably engages detents 390 of ring 380 to permit selective rotation of rotisserie 300 by incremental turns, such as, for exemplary purposes only, quarter turns.

When placing rotisserie 300 in position for use, food F is placed on side stakes 315 and/or central stakes 317, or alternately, tube 310 can be inserted through food F with subsequent insertion of central stakes 317 into tube 310. Tube 310 is hollow and is selectively removably disposed over central stakes 317 of ends 311, 312 of rotisserie 300.

First end 311 is removably disposed through and within block 400, and second end 312 is disposed within U-shaped opening 342, wherein groove 334 is carried by U-shaped opening 342. Once in position, rotisserie 300 can be rotated as required to cause food F to brown evenly.

Additionally, to permit coincident grilling of food F that requires rotation for optimum cooking along with loose items such as vegetables V, lid 140 may be left open when removable grilling basket 30 is disposed within well 130, wherein lid 140 is disposed proximate rear portion 84 of oven rack 20. Rotisserie 300, with food F thereon, may be subsequently disposed over grilling basket 30 within support block 400 and right rotisserie U-shaped support 112.

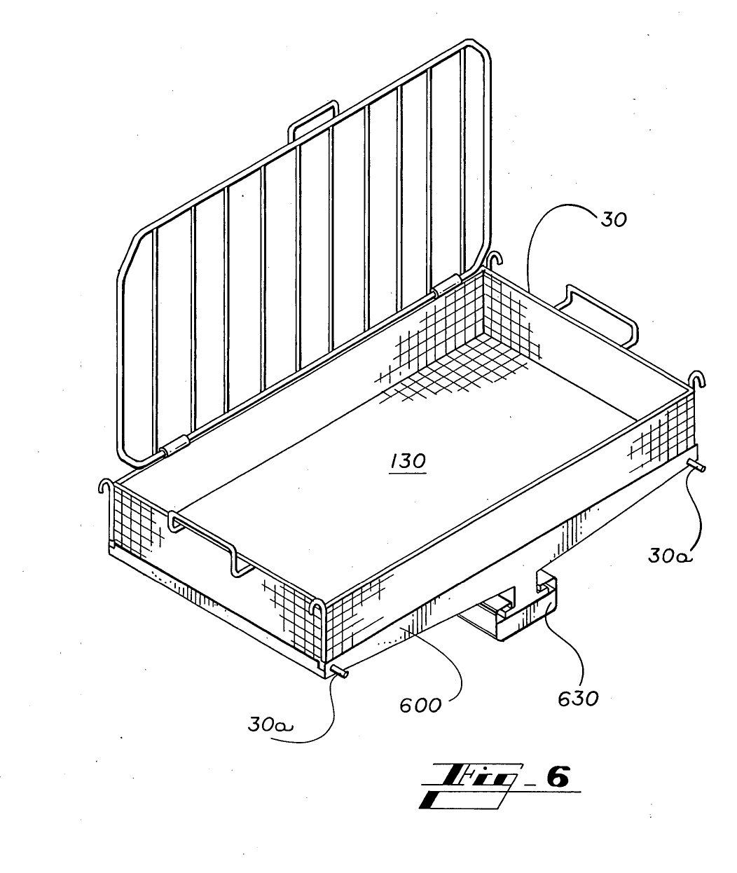

Now referring to FIGS. 6-9, grilling basket 30 may include drip pan 600 attached thereto for the collection of drippings, such as water, juice, oil, butter, grease, seasoning, crumbs, or the like, such as may fall from food items disposed within well 130. Drip pan 600 is preferably removably operable with grilling basket 30 and/or grill rack 700, such as via engagement of posts 30a, 700a, respectively with through holes 601 such that drippings from food items or the like may fall onto sloped surfaces 610 of drip pan 600, and move downward toward channel 620 and into trap 630 for collection. Thus, grease drips, crumbs, or the like, may be conveniently collected in trap 630 for disposal, whereby oven O, or a gas or charcoal grill, may be maintained in a clean state, and whereby soiling and subsequent cleaning thereof may be avoided. Such disposal may be accomplished via disengagement of trap 630 from drip pan 600, whereafter trap 630 may be transported to a sink drain, trash can, or the like for deposit of the contents thereof. As will be understood by those ordinarily skilled in the art, alternate attachment may be utilized, including a suitable arrangement of heat-resistant clips, hooks, ties, straps, or the like, and combinations thereof, to effectuate secure engagement of grilling basket 30 or grill rack 700 with drip pan 600. Furthermore, trap 630 may include a selectively sealable drain opening for facilitating evacuation thereof, or may include a disposable liner.

As will be understood by those skilled in the art, sloped surfaces 610 of drip pan 600 may function as a vaporizing surface, whereby juice or other fluid, such as a fluid dripping from a food item, may be vaporized on sloped surfaces 610. Such vaporization may beneficially increase a humidity within an oven or a grill, and may further enhance a flavor or seasoning of one or more food item(s) being cooked therewithin. When used with grill rack 700, drip pan 600 may further function as a smoker by retaining wood chips or the like either on sloped surfaces 610 or within trap 630, or both.

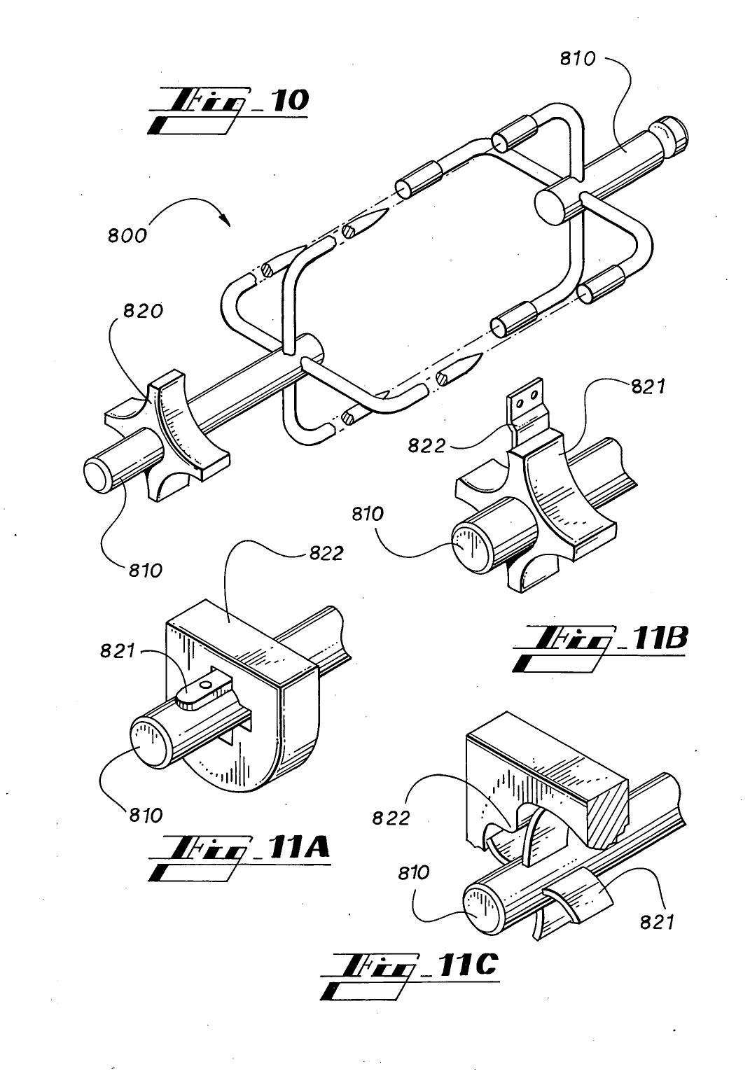

Rotisserie spit 800, shown if FIGS. 10-11C, may be used with oven rack 20, grill basket 30, or grill rack 700, such as via engagement of shaft 810 with right and left unshaped supports 110, 112, or with support block 400. As such, rotisserie spit 800 may be rotatably suspended within aperture 100 of oven rack 20, within opening 141 in lid 140 of grilling basket 30, or within opening 710 of grill rack 700. A position of rotisserie spit 800 may be controlled by positioning means 820, such as engagement of one or more tines 821 with one or more stop member 822, whereby a rotational position of rotisserie spit 800 may be adjusted as desired, such as to effectuate regular rotation of a food item to ensure even cooking. Stop member 822 may be a resilient member, whereby one or more tine may rotate therepast by overcoming a biasing force of stop member 822, or stop member 822 may be a rigid member, where tine 821 may bend to pass stop member 822, or may require disengagement from stop member 822, such as via axial sliding, in order to allow rotation of rotisserie spit 800.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A grilling apparatus comprising:
a rack having a cooking portion for supporting a food item to be cooked and having an aperture therein;
said aperture adapted to receive and support at least one of a grilling basket and a rotisserie, whereby at least one food item may be supported within said aperture for at least one of grilling and rotisserie cooking.

2. The grilling apparatus of claim 1, wherein said grilling basket comprises a lid, whereby at least one first food item may be cooked within said grilling basket, and whereby at least one second food item may be disposed on top of said lid for cooking.

3. The grilling apparatus of claim 1, further comprising a drip pan operable with said rack to collect at least one item or substance falling from said rack.

4. The grilling apparatus of claim 3, wherein said drip pan comprises a removable trap.

5. The grilling apparatus of claim 2, wherein said lid comprises a means for fastening said lid to said grilling basket.

6. The grilling apparatus of claim 1, wherein said grilling basket includes supports for receiving said rotisserie.

7. The grilling apparatus of claim 1, wherein rack further comprises supports for receiving said rotisserie.

8. The grilling apparatus of claim 1, wherein said rotisserie further comprises positioning means for controlling rotation thereof.

9. A cooking rack system comprising:
a rack comprising a cooking surface adapted to support at least one food item and a receiving means adapted to receive and support at least one of a grilling basket and a rotisserie member within an aperture of said rack;
a grilling basket;
a rotisserie member; and
a drip pan,
wherein said drip pan is removably engageable with at least one of said grilling basket, said rotisserie member, and said rack.

10. The cooking rack system of claim 9, wherein said rotisserie member is rotatably engageable with at least one of said grilling basket and said rack, and wherein a rotational position of said rotisserie member is selectively adjustable via positioning means.

11. The cooking rack system of claim 9, wherein said rack is adapted to engage a rack support of at least one of an oven and a grill.

12. The cooking rack system of claim 9, wherein said grilling basket comprises a hinged lid, said hinged lid comprising a cooking surface on which at least one food item may be placed for cooking.

13. A method of using a cooking rack, said method comprising the steps of:
providing a cooking rack, wherein said cooking rack comprises an aperture adapted to removably receive at least one of a grilling basket and a rotisserie member therein; and
supporting at least one food item on at least one surface selected from the group consisting of a cooking surface of said rack, a cooking surface of an interior of said grilling basket, a cooking surface of a lid of said grilling basket, and a cooking surface of said rotisserie member,
whereby said at least one food item may be cooked by a heat source associated with said cooking rack.

14. The method of claim 13, further comprising the step of rotating said rotisserie member.

15. The method of claim 14, wherein said step of rotating comprises manually adjusting a position of a tine of a positioning means of said rotisserie member relative to a stop member of said positioning means.

16. The method of claim 13, further comprising the step of collecting at least one dripping from a food item in a drip pan, said drip pan being removably attached to at least one of said rack and said grilling basket.

17. The method of claim 13, further comprising the step of smoking at least one food item using a drip pan, said drip pan being removably attached to at least one of said rack and said grilling basket.

18. The method of claim 13, wherein the heat source cooks the at least one food item via at least one of grilling and browning.
